(19) United States
(12) Patent Application Publication
(10) Pub. No.: US 2005/0099395 A1
(43) Pub. Date: May 12, 2005

(54) Assistive technology interface

(76) Inventors: Randal J. Marsden, Edmonton (CA); Clifford A. Kushler, Lynnwood, WA (US)

Correspondence Address: Michael S. Smith;BLACK LOWE & GRAHAM PLLC, Suite 4800, 701 Fifth Avenue, Seattle, WA, 98104, US

(21) Appl. No.: 10/981,874

(22) Filed: Nov. 5, 2004

Related U.S. Application Data
(60) Provisional application No. 60/517,649, filed on Nov. 6, 2003.

(51) Int. Cl. G09G 5/00

(52) U.S. Cl. 345/168

(57) ABSTRACT

A hardware interface device controlled by assistive technology software residing on a computer. The hardware interface device posts and intercepts external keyboard and mouse events. The hardware interface device sends the keyboard and mouse commands into the computer from the hardware interface device in a manner such that the keyboard and mouse commands received by the computer are indistinguishable by the operating system from those received from standard mouse and keyboard hardware.

### PRIORITY CLAIM

This application claims priority from U.S. Provisional Application Ser. No. 60/517,649 filed Nov. 6, 2003, the contents of which are hereby incorporated by reference.

### BACKGROUND OF THE INVENTION

People with certain types of disabilities find it difficult or impossible to control a computer using a conventional keyboard or mouse. There are many different assistive technology solutions that replace the keyboard and mouse for people with disabilities and help them access and control the computer. Some of these assistive technology solutions are based on software that emulates keyboard and mouse commands to the rest of the computer (FIG. 1). These solutions must also occasionally filter incoming mouse and keyboard signals, change them into something else and then re-insert them into the operating system.

The problem is that today's computer operating systems were not designed to allow software to fully emulate external keyboard and mouse commands or to completely filter them. Assistive technology software must often resort to “hacks” or “kludges” to accomplish these tasks. But without an OS-supported solution, these hacks are only marginally successful, with compatibility problems and partial functionality being common.

Operating system manufacturers are aware of this shortcoming and have explored ways to correct it. Unfortunately, allowing a software program to intercept keyboard and mouse commands and then change them into something else poses a serious security risk. If this were possible then, for example, malicious software could spy on passwords, post false keyboard commands, and cause other damage to the computer. So, the requirements of assistive technology software and that of security measures appear to be in direct conflict with one another.

An important example of the conflict between the need for computer security and the requirements of assistive technology is the Login Screen. The Login Screen is the computer window that optionally appears when the computer is turned on, requiring the operator to enter a username and affiliated password. The purpose of the Login Screen is to provide security by blocking unauthorized persons access to the computer and the data stored on it. The operator is required to interact with the computer's Login Screen by using an external keyboard to enter the necessary textual information. The problem is many people with disabilities can't physically access or control an external keyboard. Alternative input methods, such as on-screen keyboard software, are not supported by the computer's operating system during Login, for security purposes. If third-party software were allowed to be loaded and run during Login, then malicious programmers could write software that could “spy” on the operator's private username and password thus violating their security. The security demands of the computer's operating system are in direct conflict with assistive technology requirements.

There have been numerous schemes devised that use existing tools provided by a computer operating system whereby one software application can trick other software applications running on the computer into thinking that external user input has occurred. For example, U.S. Pat. No. 5,392,386 to Chalas describes a way of simulating user input via software using the “Clipboard” memory provided by the operating system. Other approaches use means that are at a lower level in the operating system than the clipboard and rely on unsupported “kludges” to get the job done.

There are numerous problems with the software-to-software approach, the main one being that with the current operating systems, it is impossible to simulate external user input in such a way that it is identical to that received from an external hardware device, and in such a way that it is functionally indistinguishable from input received from an external hardware device. Chalas, for example, relies on the use of the clipboard, which not all applications support. Further, it relies on a kludge to intercept user input and store it to the Clipboard—something that may not always be possible if the operating system changes.

In the end, the software-to-software approach to user input simulation will always be problematic unless a supported method is provided by the operating system manufacturers to simulate hardware-based input events in software. Such a method is unlikely to ever be provided due to the potential threat that would pose to the security of the operating system itself.

There have been yet other schemes whereby special hardware interfaces have been provided to allow people with disabilities to access the computer. Silva et al. (U.S. Pat. No. 5,450,078) describe a membrane keyboard interface that allows for a plurality of overlays to be detected when placed over the membrane keyboard and the functionality of each membrane switch of the membrane keyboard to be individually assigned according to the current overlay. In this case, the action is initiated by the operator interacting with the specialized membrane keyboard that already has pre-stored in its memory the scan codes associated with each membrane switch. Silva acknowledges incompatibilities that can arise if non-standard codes are sent to special software on the computer which then tries to “simulate” the key press event, and therefore recommends sending scan codes directly to the computer's keyboard port.

### SUMMARY OF THE INVENTION

One embodiment of the present invention includes a hardware interface device that is controlled by assistive technology software. In one preferred embodiment, the hardware interface is based upon the standard USB serial communications protocol which is commonly used for communication between computers and hardware peripherals such as mice and keyboards. In another embodiment, the communication interface between the interface device and the computer with which it is used is based upon the standard “Bluetooth” wireless communications protocol, which is also commonly used for communication between computers and hardware peripherals such as mice and keyboards. The hardware interface device posts keyboard and mouse events to the computer to be processed “natively”, just as keyboard and mouse events are processed that are received from standard hardware keyboards and mice. The hardware interface device also intercepts external keyboard and mouse events received from hardware (including, but not limited to, standard hardware keyboards and mice) attached to the interface device. The present invention sends apparent keyboard and mouse commands into the computer from the hardware interface device such that these commands are indistinguishable from commands that are sent from standard mouse and keyboard hardware. By so doing, there is no need to circumvent internal security software measures implemented by the operating system in an attempt to internally simulate externally received keyboard and mouse events.

### BRIEF DESCRIPTION OF THE DRAWINGS

The preferred and alternative embodiments of the present invention are described in detail below with reference to the following drawings.

FIG. 1 is a block diagram illustrating the prior art;

FIGS. 2-5 are block diagrams illustrating embodiments of the present invention; and

FIG. 6 illustrates an example of an embodiment of the present invention.

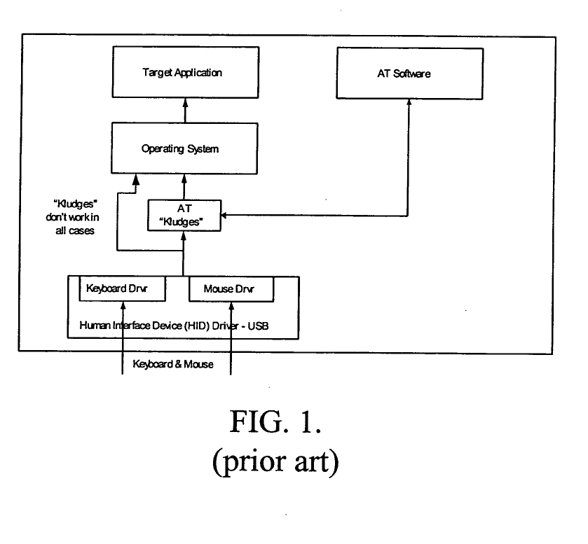

### DETAILED DESCRIPTION OF THE PREFERRED EMBODIMENT

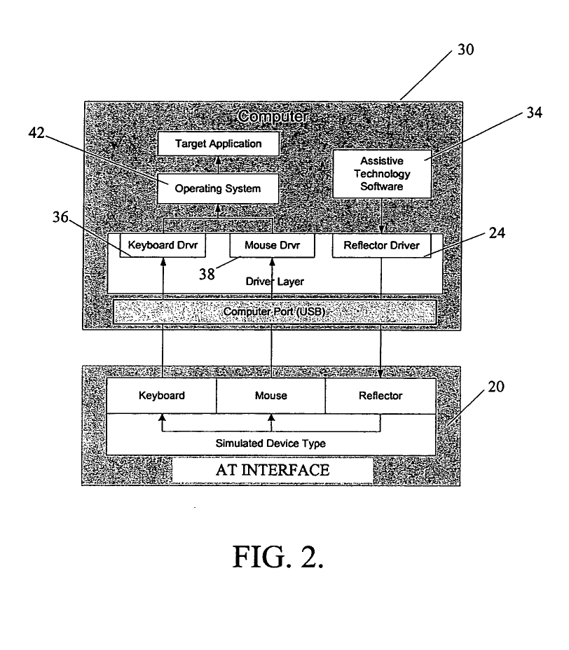

In one preferred embodiment as shown in FIG. 2, the present invention includes an assistive technology hardware interface device (“AT Interface”) 20 and a corresponding driver (“reflector driver”) 24 located on a computer 30. Assistive technology (AT) software 34 is stored in memory 44 of the computer 30. The AT software 34 communicates with the AT Interface 20 through the reflector driver 24. For example, the AT software 34 can instruct the AT Interface 20 to post keyboard and mouse commands that are received and processed by the keyboard and mouse drivers 36 and 38 of the computer 30. The AT Interface 20 receives external keyboard and mouse signals from devices that are connected through the AT Interface 20 and routes them directly to the AT software 34, initially bypassing an operating system 42 of the computer 30. In this way, the AT software 34 can filter and/or change external user input events as required before sending them back to the AT Interface 20 so that the filtered and/or changed input events can then be actually sent on through (once again formatted as standard keyboard and mouse signals) to the keyboard and mouse drivers 36 and 38. Alternatively, the AT software 34 can determine that it is appropriate to completely eliminate the input altogether by not sending it back to the AT Interface 20.

The AT Interface 20 communicates with the drivers of the computer via a data connection such as a Universal Serial Bus (USB) port, PS2 ports, a Bluetooth wireless connection, a serial port, a parallel port, an IEEE 1394 (“Firewire”) port, a computer card bus slot, or other wired or wireless communication means, or any combination of the above.

The AT Interface 20 performs one or more of the following four functions:
1. Simulation of mouse and keyboard commands;
2. Re-direction of external mouse and keyboard input;
3. Acting as an interface for other assistive technology input devices;
4. Providing the capability to store and issue user login information, such as username and password.

These functions are described in the sections below.

1. Keyboard & Mouse Simulation

As shown in FIG. 2, with the AT Interface 20 in reflector mode, assistive technology (“AT”) software simulates user keyboard and mouse input to control software applications running on the computer. For example, AT software 34 can post a keyboard command such as “type the letter A” by sending a command to the AT Interface 20 via the reflector driver 24. The AT Interface 20 then reports itself to the computer as a regular keyboard and posts a key event for the “A” key. This will appear to the computer exactly the same as if someone had pressed the “A” key on a standard external keyboard. The standard keyboard driver and operating system 42 handle the command from there in the normal way.

Similarly for mouse input, assistive technology software can instruct the AT Interface 20, through the reflector driver 24, to post mouse events to the computer via the standard mouse driver channels.

2. Re-Direction of External Mouse and Keyboard Input

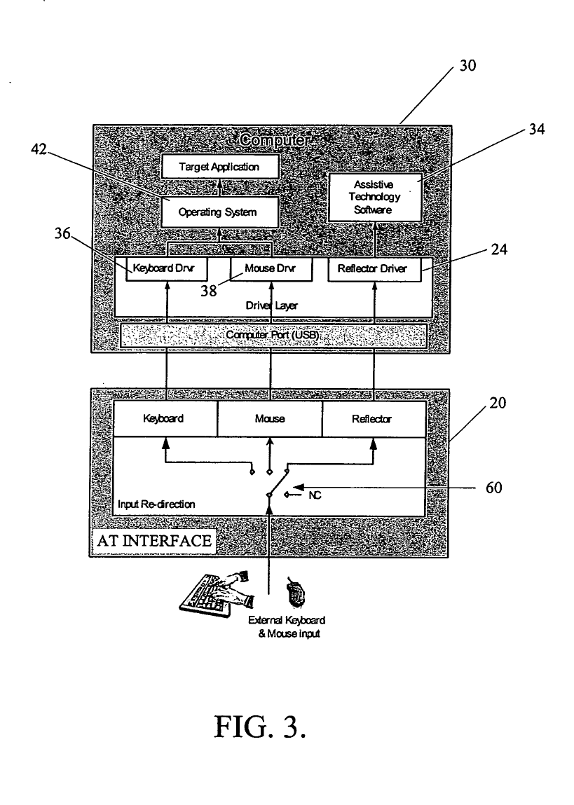

As shown in FIG. 3, the second function of the AT Interface 20 is to re-route external mouse and keyboard commands as required. Instead of sending mouse or keyboard commands to the computer's mouse and keyboard drivers 36 and 38, the AT Interface 20 can re-direct them to AT software 34 via the reflector driver 24. The distinguishing data within the received mouse and keyboard commands (specifying which key was pressed or how the mouse was moved) is re-formatted so that the data can be sent through the shared communication channel (for example, the standard USB interface) to AT Software 34 without being recognized and processed as actual mouse and keyboard commands by the computer's mouse and keyboard drivers 36 and 38.

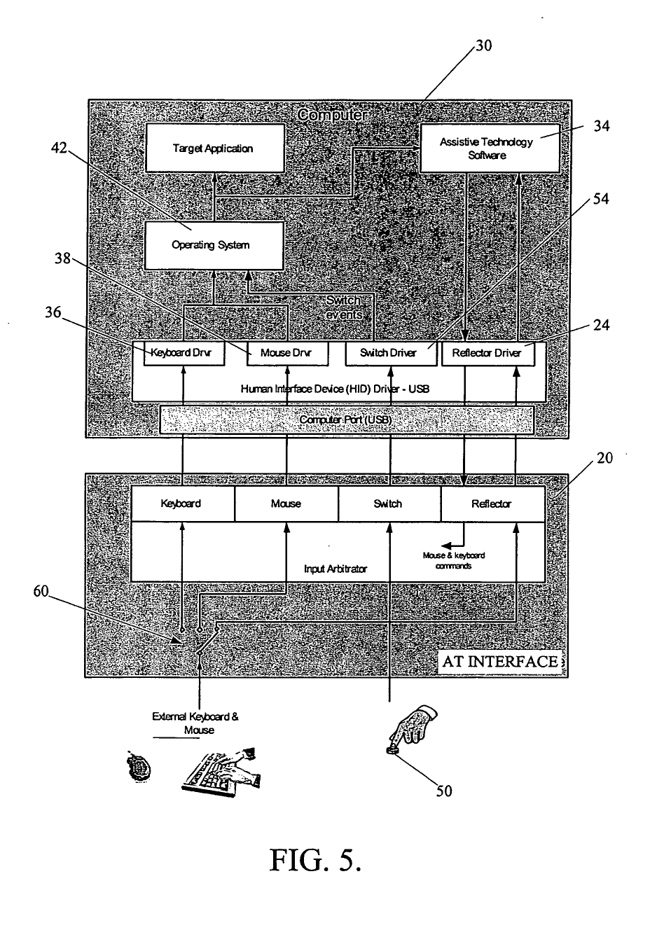

This scheme is useful in cases where incoming signals from the keyboard or mouse are to be filtered (as shown in FIG. 5), or perhaps blocked altogether. It gives AT software 34 complete control over how external user input is to be treated. The AT software 34 can instruct the AT Interface 20 which direction to send the input: through the normal keyboard and mouse drivers 36 and 38, through the reflector driver 24 to AT software 34, or to simply block it completely.

3. Switch Interface

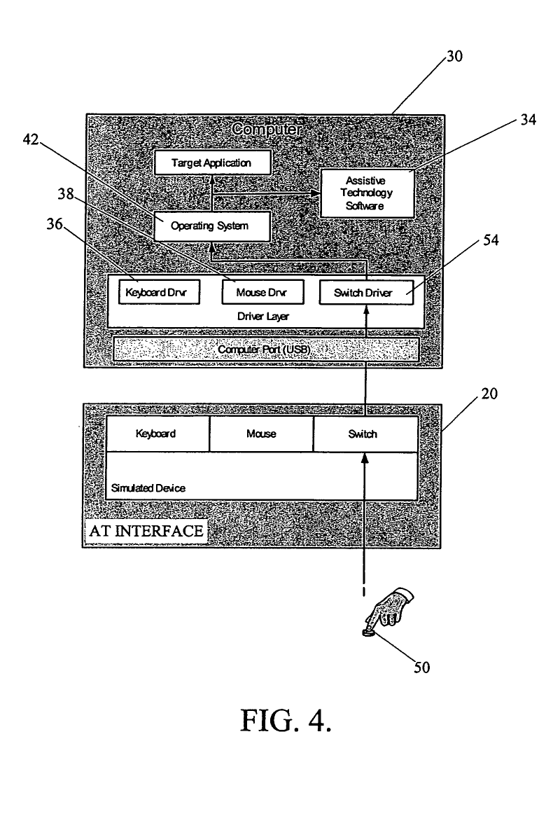

As shown in FIG. 4, a third function of the AT Interface 20 is to act as a hardware interface for external switches 50 used by people with disabilities (e.g., ability switches). Many people with disabilities use the switch 50 to interface with the computer 30. Since there is no place to plug these switches directly into the computer 30, the AT Interface 20 provides the interface.

This approach utilizes a switch driver 54 that is analogous to the current use of a keyboard driver, where when a key is pressed on an external hardware keyboard it generates a signal that is received and processed by a keyboard driver on the computer. The keyboard driver interprets the data contained in the signal and generates the internal system software event that communicates the corresponding keyboard event to the currently running application software. No such mechanism exists for a generic, external “ability switch” that is commonly used by accessible software to, for example, control software that scans through a sequence of possible selections, such that when the user's desired selection is highlighted by the scan, the user can close the switch to activate that selection. This approach is useful for someone with a disability that makes it difficult to accurately select from a large number of switches—such as the keys on a keyboard—but who is able to reliably activate one or more special “ability switches” to control various types of scanning selection techniques. The proposed approach allows one (or more) such special switches (which currently have no mechanism in operating systems such as Windows to interact with various applications) to be identified at the operating system level so that the same switch (or switches) can be used with more than one application just as the keyboard can be used with multiple applications. Currently, each “switch-aware” application needs to have its own special hardware interface and dedicated switch.

Switch driver 54 is part of the operating system 42 similar to the mouse and keyboard drivers 36 and 38. In this way, any software that is able to process and respond to ability switch input can be notified of external switch events. This means only one hardware switch interface would be required to support multiple software titles that required switch input.

4. Login Information

In one embodiment, the AT Interface 20 is equipped with non-volatile memory (not shown) that stores information required during computer Login, such as a username and password. This information can be retrieved and sent to the computer as external keyboard commands by the AT Interface 20. This action can be triggered, for example, by the operator activating a switch connected to the Switch Interface in a distinctive manner, or by activating a switch when the AT Interface 20 is in a special operating mode. Thus, this approach satisfies both the need for security during Login and the requirements for alternative interfaces for people with disabilities. To enable the user to activate the Login sequence without performing a distinctive (and therefore more complex) input action, the AT Interface 20 is placed into a special “Login Mode” by one or more of a number of triggering events resulting in user Logout, which include, but are not limited to, the following:
Computer Shutdown initiated by software (menu Shutdown)
Computer Power-down initiated by the computer's power switch
General failure in electrical power supplied to the computer
Low battery condition
Sleep condition
User Logout
Computer Restart (via software)

As a further security enhancement, the operator may pre-store a customized input sequence, which must be entered before the Login Information is issued by the AT Interface 20 to the computer. For example, the sequence may be a series of specially timed switch actuations executed by the operator using a switch connected to the AT Interface 20 (long-short-short=“issue Login Information”). This customized input sequence could be programmed to be actionable only after a Logout event, or at all times, depending on the abilities and desire of the operator.

Functional Integration

The combination of the functions 1-3 of the AT Interface 20 (Simulation, Re-Direction, and Switch interface) are represented in the FIG. 5.

Driver Commands

The following are examples of some, but not all, of the commands that the reflector driver 24 may support (running and working in conjunction with firmware running on the AT Interface 20):
Post Keyboard Event (keycode)
Post Mouse Event (delta x, delta y, mouse button)
Re-route/restore external mouse input to AT software 34
Re-route/restore external keyboard input to AT software 34
Enable/Disable external mouse input
Enable/Disable external keyboard input
Assign external switch function
Store Login Information
Issue Login Information
   Examples of Driver Commands
   Control-Alt-Delete

An example of a function that is not possible to perform using currently available on-screen keyboards is the key combination control-alt-delete (to invoke the Task Manager, for example). That is a special low-level command that appears to only be possible when executed by a real external keyboard.

This problem is also rectified with the use of the AT Interface 20. Onscreen keyboards (AT software 34) instruct the AT Interface 20 (via the reflector driver 24) to post the key combination of control-alt-delete. The computer receives the post in exactly the same manner as it does when the key combination is posted by an external physical keyboard, and the Task Manager is successfully invoked.

Constrained Cursor

Some AT software 34 presents a special cursor that is constrained only to the AT software 34's own window. In such cases, there is a need to block movement of the computer's regular cursor in order to avoid confusion. Unfortunately, in today's operating systems 42 it is impossible to block movement of the computer's cursor. Consequently, the user is left to deal with two separate cursors that are both moving on the screen.

The AT software 34 instructs the AT Interface 20 to re-direct the mouse input directly to it through the reflector driver 24. The computer's mouse driver never sees the incoming mouse commands and thus the computer's cursor remains still.

Filtered Mouse Input

Many people with disabilities lack the ability to accurately control a mouse pointing device. Someone with Parkinson's disease, for example, may experience tremors while trying to move the cursor. In one embodiment, the incoming mouse signal is filtered (e.g. smoothed or re-scaled) before sending it to the computer's mouse driver.

Such a scheme can be accomplished with the AT Interface 20. The AT software 34 instructs the AT Interface 20 to re-direct all external mouse movement signals directly to the AT software 34. The AT software 34 filters the external mouse movement signals and re-inserts the modified/filtered mouse signals into the computer via the AT Interface 20 and mouse driver.

Login Macro

With the AT Interface 20 attached, a login macro could be assigned as the action to be performed in response to an external switch activation, mouse gesture, or other type of accessible input action. The keystrokes necessary for login would then be automatically entered by the AT Interface 20 directly.

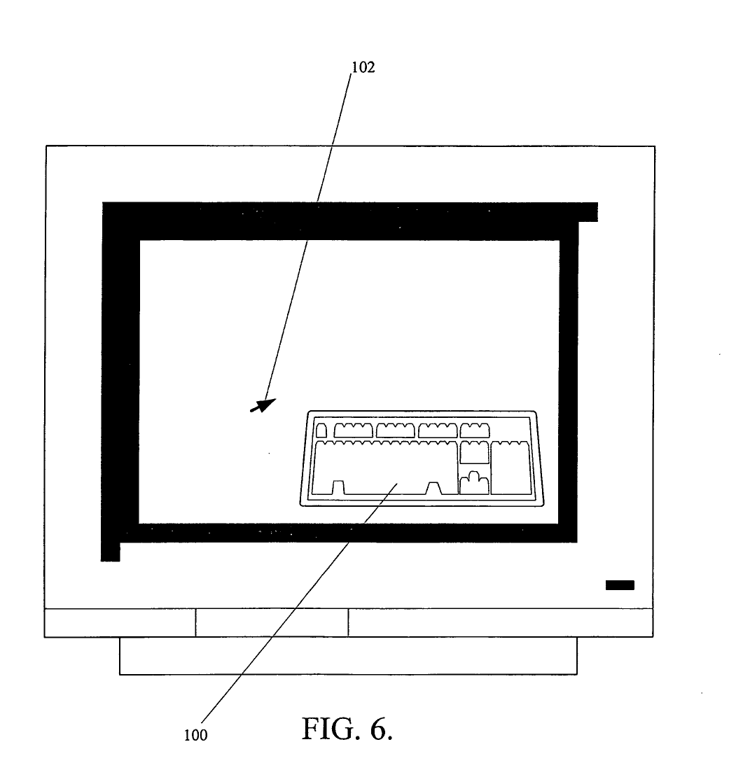

As shown in FIG. 6, an on-screen keyboard 100 is presented on a display. A user using a cursor control device or mouse controls the movement of a cursor 102. The cursor control device or mouse is connected to the AT Interface 20. The AT Interface 20 sends cursor control signals to AT software 34 in the computer 30. If the AT software 34 determines that the cursor is located outside of the on-screen keyboard 100, the cursor control signals are sent to the proper driver of the computer 30 via the AT Interface 20. However, if the cursor is located within the on-screen keyboard 100, the cursor control signals are scaled in order to allow a near full range of user motion of the cursor control device or mouse to be translated to movement of the cursor 102 within the on-screen keyboard 100. The scaled signals are sent to the proper driver of the computer 30 via the AT Interface 20.

While the preferred embodiment of the invention has been illustrated as it may apply to assistive technology solutions for people with disabilities, many other applications can be made without departing from the spirit and scope of the invention. For example, the same reflector properties of the AT Interface 20 may be employed by voice recognition software wishing to issue exact keyboard commands (such as Control-Alt-Delete). Other useful applications of the AT Interface 20 include data acquisition, environmental control, and inter-application communication.

While the preferred embodiment of the invention has been illustrated and described, as noted above, many changes can be made without departing from the spirit and scope of the invention. For example, the drivers and other components illustrated and described above may be implemented in various formats, such as software, hardware, firmware or a combination of any of these. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
using at least one communication channel between a computer and an interface device;
generating at least two distinct identification signals at the external device, wherein at least one identification signal identifies an external device that the interface device is simulating, and at least one identification signal identifies an interface device that is able to simulate at least one external device;
sending the interface device identification signal to the computer;
generating first user interface command signals by an application program executed by the computer;
sending the generated first user interface command signals to the interface device;
generating second user interface command signals by the interface device based on the received first user interface command signals;
sending the external device identification signal to the computer;
sending the generated second user interface command signals to the computer to be processed by driver software of the computer that corresponds to the external device simulated by the interface device; and
processing the second user interface command signals at the computer in the same manner as user interface command signals that are received from the external device being simulated.

2. The method of claim 1, wherein the external device simulated by the interface device is at least one of a keyboard, mouse, cursor control device, or switch.

3. The method of claim 2, wherein the cursor control device includes at least one of a head pointer, a joystick, a graphics tablet, or a touch-pad.

4. The method of claim 1, wherein the application program is an assistive technology application program.

5. The method of claim 4, wherein the assistive technology application program is at least one of an on-screen keyboard, an application to provide augmentative and alternative communication functionality, or software to provide alternative means for controlling cursor movement.

6. The method of claim 1, wherein the at least one communication channel is at least one of a wired or wireless connection.

7. A system comprising:
a computer comprising:
a processor for executing an application program, the application program generates first user interface command signals;
an interface device in data communication with the computer, the interface device comprising:
a component for receiving the first user interface command signals from the computer; and
a component for generating second user interface command signals based on the received first user interface command signals; and
a component for sending the generated second user interface command signals to the computer to be processed by driver software of the computer that corresponds to an external device being simulated by the interface device; and
wherein the processor processes the second user interface command signals in the same manner as user interface command signals that are received from the external device being simulated.

8. The system of claim 7, wherein the external device simulated by the interface device is at least one of a keyboard, mouse, cursor control device, or switch.

9. The method of claim 8, wherein the cursor control device includes at least one of a head pointer, a joystick, a graphics tablet, or a touch-pad.

10. The system of claim 7, wherein the application program is an assistive technology application program.

11. The system of claim 10, wherein the assistive technology application program is at least one of an on-screen keyboard, an application to provide augmentative and alternative communication functionality, or software to provide alternative means for controlling cursor movement.

12. The system of claim 7, wherein the computer is in data communication with the interface device via at least one of a wired or wireless connection.

13. A method comprising:
receiving user input signals at an interface device from an external user input device;
sending the received user input signals to an application program via an interface device driver on a computer; and
generating user input signals compatible with an external input device driver on a computer based on the received user input signals;
sending the generated user input signals to the interface device via the interface device driver; and
re-sending the user input signals received at the interface device from the interface device driver to the operating system of the computer via the external input device driver.

14. The method of claim 13 further comprising directly sending the user input signals received from an external user input device by the interface device to an operating system of the computer via an external input device driver associated with the user input device.

15. The method of claim 13, wherein the user input device is at least one of a keyboard, mouse, cursor control device, or switch.

16. The method of claim 15, wherein the cursor control device includes at least one of a head pointer, a joystick, a graphics tablet, or a touch-pad.

17. The method of claim 13, wherein the application program is an assistive technology application program.

18. The method of claim 13, wherein the computer is in data communication with the interface device via at least one of a wired or wireless connection.

19. The method of claim 13, further comprising:
generating a login signal at the device based upon a user action; and
sending the generated login signal to the computer.

20. A system comprising:
a user input device for generating first user input signals;
an interface device for receiving the generated first user input signals; and
a computer in data communication with the interface device, the computer comprising:
an application program;
an interface device driver; and
a user input device driver associated with the user input device,
sending the first user input signals from the interface device to the application program via the interface device driver; and
the application program generating second user input signals compatible with the user input device driver based on the first user input signals and sending the generated second user input signals to the interface device via the interface device driver; and
the interface device sending the second user input signals received from the interface device driver to the operating system of the computer via the user input device driver.

21. The system of claim 20 further comprising directly sending the first user input signals received from the user input device by the interface device to an operating system of the computer via the user input device driver associated with the user input device.

22. The system of claim 20, wherein the user input device is at least one of a keyboard, mouse, cursor control device, or switch.

23. The system of claim 22, wherein the cursor control device includes at least one of a head pointer, a joystick, a graphics tablet, or a touch-pad.

24. The system of claim 20, wherein the application program is an assistive technology application program.

25. The system of claim 20, wherein the computer is in data communication with the interface device via at least one of a wired or wireless connection.

26. The system of claim 20, wherein the device generates a login signal at the device based upon a user action and sends the generated login signal to the computer.

27. A method comprising:
generating first user interface command signals by an application program executed by a computer;
sending the generated first user interface command signals to an interface device;
generating second user interface command signals by the interface device based on the received first user interface command signals;
sending the external device identification signal to the computer;
sending the generated second user interface command signals to the computer to be processed by driver software of the computer that corresponds to the external device simulated by the interface device; and
processing the second user interface command signals at the computer in the same manner as user interface command signals that are received from the external device being simulated.
